(19) United States
(12) Patent Application Publication
(10) Pub. No.: US 2022/0379531 A1
(43) Pub. Date: Dec. 1, 2022

(54) Injection Molding Apparatus

(71) Applicant: Seiko Epson Corporation, Tokyo (JP)

(72) Inventors: Hidenobu MARUYAMA, Azumino (JP); Kenta ANEGAWA, Matsumoto (JP); Keisuke AKIMOTO, Azumino (JP); Kei YOKOTA, Matsumoto (JP); Yasuto KANAI, Ota (JP)

(21) Appl. No.: 17/751,723

(22) Filed: May 24, 2022

(30) Foreign Application Priority Data
May 25, 2021 (JP) 2021-087682

(51) Int. Cl. B29C 45/13; B29C 45/00; B29C 45/04; B29C 45/16; B29C 45/40

(52) U.S. Cl. CPC B29C 45/13; B29C 45/0005; B29C 45/04; B29C 45/16; B29C 45/401

(57) ABSTRACT

An injection molding apparatus includes a fixed die having a first gate opening and a second gate opening formed therein, a movable die configured to be clampable to the fixed die, a first injection unit that injects a first molding material into a cavity defined by the fixed die and the movable die via the first gate opening, and a second injection unit that injects a second molding material into the cavity via the second gate opening.

The present application is based on, and claims priority from JP Application Serial Number 2021-087682, filed May 25, 2021, the disclosure of which is hereby incorporated by reference herein in its entirety.

### BACKGROUND

### 1. Technical Field

The present disclosure relates to an injection molding apparatus.

### 2. Related Art

The injection molding apparatus disclosed in JP-A-2010-241016 includes a plasticizer that plasticizes a material with the aid of a rotor having a helical groove formed in an end face of the rotor and a barrel in contact with the end surface of the rotor.

Employing the rotor disclosed in JP-A-2010-241016 allows reduction in size of the plasticizer. In general, however, when injection molding is performed by using a molding die with a cavity having a large projected area, large injection pressure and large die clamping pressure are necessary, resulting in difficulty in reducing the size of the entire plasticizer.

### SUMMARY

According to a first aspect of the present disclosure, an injection molding apparatus is provided. The injection molding apparatus includes a fixed die having a first gate opening and a second gate opening formed therein, a movable die configured to be clampable to the fixed die, a first injection unit that injects a first molding material into a cavity defined by the fixed die and the movable die via the first gate opening, and a second injection unit that injects a second molding material into the cavity via the second gate opening.

### BRIEF DESCRIPTION OF THE DRAWINGS

FIG. 1 is a front view showing a schematic configuration of an injection molding apparatus according to a first embodiment.

FIG. 2 is a side view showing the schematic configuration of the injection molding apparatus.

FIG. 3 is a cross-sectional view showing a schematic configuration of an injection unit.

FIG. 4 is a perspective view showing a schematic configuration of a flat screw.

FIG. 5 is a schematic plan view of a barrel.

FIG. 6 is a diagrammatic view showing that a molding die undergoes die opening.

FIG. 7 is a diagrammatic view showing the die opening in Comparative Example.

FIG. 8 is a first view showing an example of the arrangement of the injection units with respect to a cavity.

FIG. 9 is a second view showing an example of the arrangement of the injection units with respect to the cavity.

FIG. 10 shows an example in which a plurality of cavities are formed in the molding die.

FIG. 11 shows a schematic configuration of an injection molding apparatus according to a second embodiment.

FIG. 12 is a descriptive diagram showing an example of a molding process in the second embodiment.

FIG. 13 shows variations of multicolor molding.

### DESCRIPTION OF EXEMPLARY EMBODIMENTS

### A. First Embodiment

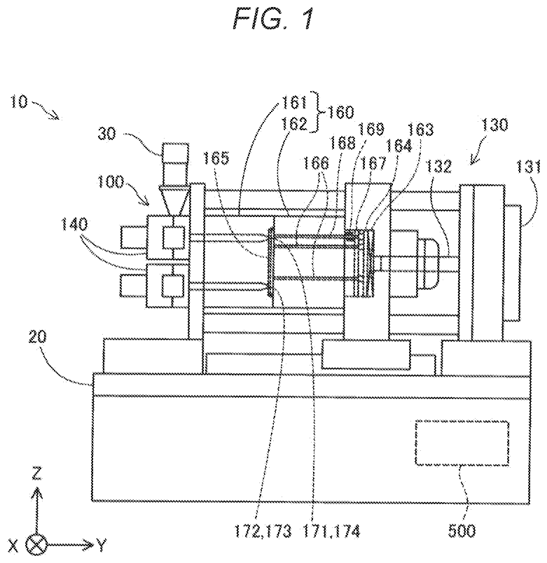

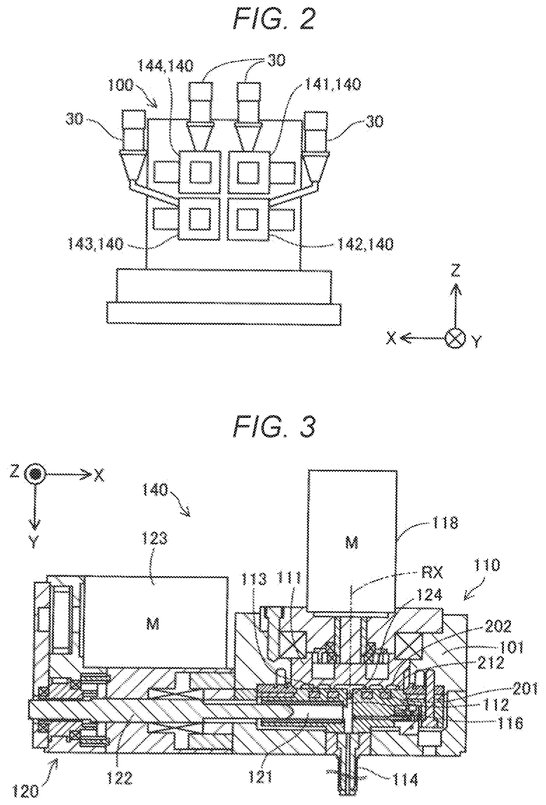

FIG. 1 is a front view showing a schematic configuration of an injection molding apparatus 10 according to a first embodiment. FIG. 2 is a side view showing the schematic configuration of the injection molding apparatus 10. FIGS. 1 and 2 show arrows indicating directions X, Y, and Z perpendicular to one another. The directions X and Y are directions parallel to the horizontal plane, and the direction Z is the direction opposite the gravitational direction. The directions X, Y, and Z shown in FIG. 3 and the following figures correspond to the directions X, Y, and Z shown in FIGS. 1 and 2. In the following description, positive and negative signs are also used to specify an orientation in the direction notation as follows: “+” represents a positive direction, which is the direction indicated by an arrow; and “−” represents a negative direction, which is the direction opposite the direction indicated by the arrow.

The injection molding apparatus 10 includes an injector 100 and a die clamper 130, as shown in FIG. 1. The injection molding apparatus 10 is a horizontal injection molding apparatus, and the injector 100 and the die clamper 130 are arranged in the horizontal direction. The injector 100 and the die clamper 130 are each fixed to a base 20. The base 20 is provided with a controller 500. The injection molding apparatus 10 injects a molding material from the injector 100 into a molding die 160 installed in the die clamper 130 to form a molded product. In the present embodiment, a metal molding die 160 is installed in the die clamper 130. The molding die 160 installed in the die clamper 130 is not necessarily made of metal and may instead be made of resin or ceramic. The metal molding die 160 is called a die. The molding die 160 includes a fixed die 161 and a movable die 162. The fixed die 161 is a die fixed to the injector 100, and the movable die 162 is a die that moves relative to the fixed die 161 and is configured to be clampable to the fixed die 161. The fixed die 161 is also called a first die or a female die, and the movable die 162 is also called a second die or a male die.

The die clamper 130 has the function of separating the fixed die 161 and the movable die 162 from each other and joining the two dies to each other. Under the control of the controller 500, the die clamper 130 rotates a ball screw 132 by driving a die driver 131 formed of a motor to move the movable die 162 coupled to the ball screw 132 relative to the fixed die 161 to open and close the molding die 160. That is, the fixed die 161 is stationary in the injection molding apparatus 10, and the movable die 162 moves relative to the stationary fixed die 161 to open and close the molding die 160. In the present embodiment, the movable die 162 moves in the direction −Y, which is a direction that intersects with the vertical direction, to perform the die clamping.

One or more ejector pins 166 are embedded in the movable die 162. The ejector pins 166 are each a rod-shaped member that releases the molded product formed in a cavity 165 from the movable die 162 when the movable die 162 is moved. The ejector pins 166 are provided so as to pass through the movable die 162 and reach the cavity 165. The rear end of each of the ejector pins 166 is supported by a support plate 167. A support rod 168 is fixed to the support plate 167, and inserted into a through hole formed in the movable die 162. A spring 169, which is disposed in the space between the movable die 162 and the support plate 167, is inserted into the support rod 168. The spring 169 urges the support plate 167 in such a way that the head of each of the ejector pins 166 forms part of the wall surface of the cavity 165 during molding. An extrusion plate 164 is fixed to a surface of the support plate 167, the surface facing the ball screw 132. A thrust bearing 163 is attached to a surface of the extrusion plate 164, the surface facing the ball screw 132. The head of the ball screw 132 is allowed to come into contact with the thrust bearing 163. The thrust bearing 163 may be replaced, for example, with a thrust slide bearing.

The injector 100 includes a plurality of injection units 140. In the present embodiment, the plurality of injection units 140 include a first injection unit 141, a second injection unit 142, a third injection unit 143, and a fourth injection unit 144, as shown in FIG. 2. When the injection units are not distinguished from one another, the injection units are simply referred to as the injection units 140. In the present embodiment, the injection units 140 are arranged in two rows in each of the directions X and Z in the injector 100.

A hopper 30, into which the material of the molded product is loaded, is coupled to each of the injection units 140. The material of the molded product is, for example, thermoplastic resin shaped into a pellet. The thermoplastic resin is, for example, ABS (acrylonitrile butadiene styrene), PC (polycarbonate), POM (polyacetal), PP (polypropylene), or PBT (polybutylene terephthalate). The same material or different materials can be loaded into the hoppers 30 provided in the injection units 140. In the present embodiment, the same material is loaded into all the hoppers 30. The material is not necessarily supplied to the injection units 140 via the hoppers 30, and may instead be supplied, for example, via tubes through which the material is delivered under pressure.

The injection units 140 each plasticize at least part of the material supplied from the hopper 30 to produce the molding material, and injects the molding material toward the cavity 165 defined between the fixed die 161 and the movable die 162. In the present embodiment, the term “plasticize” means that a material having thermal plasticity is heated and melted. The term “melted” means not only that a material having thermal plasticity is heated to a temperature higher than or equal to the melting point of the material and changed into a liquid form, but that the material having thermal plasticity softens when heated to a temperature higher than or equal to the glass transition point so that the material exhibits fluidity.

A first gate opening 171, a second gate opening 172, a third gate opening 173, and a fourth gate opening 174 are formed in the fixed die 161. A first molding material is injected toward the cavity 165 from the first injection unit 141 via the first gate opening 171. A second molding material is injected toward the cavity 165 from the second injection unit 142 via the second gate opening 172. A third molding material is injected toward the cavity 165 from the third injection unit 143 via the third gate opening 173. A fourth molding material is injected toward the cavity 165 from the fourth injection unit 144 via the fourth gate opening 174.

In the present embodiment, the second injection unit 142 injects the second molding material into the cavity 165, into which the first injection unit 141 injects the first molding material. The third injection unit 143 injects the third molding material into the cavity 165, into which the first injection unit 141 and the second injection unit 142 inject the first molding material and the second molding material. The fourth injection unit 144 injects the fourth molding material into the cavity 165, into which the first injection unit 141, the second injection unit 142, and the third injection unit 143 inject the first molding material, the second molding material, and the third molding material. In the present embodiment, the first, second, third, and fourth molding materials are identical to one another.

In the present embodiment, the molded product is molded by performing operation once including the die clamping of the fixed die 161 and the movable die 162 and the injection from the injection units 140 toward the cavity 165 via the respective gate openings. That is, the molded product is not formed by injection performed a plurality of times but is formed by injection performed once.

The controller 500 is formed of a computer including one or more processors, a primary storage device, and an input/output interface via which signals are inputted from and outputted to an external apparatus. The processor reads a program onto the primary storage device and executes the program to allow the controller 500 to control the injector 100 and the die clamper 130 to manufacture the molded product. The controller 500 can separately set injection conditions for the injection units 140. The injection units 140 can inject the molding material in accordance with the separately set injection conditions. The injection conditions include, for example, at least one of injection pressure, injection speed, injection temperature, and injection timing.

FIG. 3 is a cross-sectional view showing a schematic configuration of each of the injection units 140. In FIG. 3, each portion is so drawn that the direction +Y, which is oriented rightward in FIG. 1, is oriented downward for convenience of illustration. The injection units 140 each include a plasticizer 110, an injection control mechanism 120, and a nozzle 114.

The plasticizer 110 includes a flat screw 111, a barrel 112, and heaters 113. The flat screw 111 is housed in a housing 101. The flat screw 111 is also called a rotor or simply a screw. The flat screw 111 is rotationally driven by a drive motor 118 around an axis of rotation RX in the housing 101. In the present embodiment, the direction of the axis of rotation RX extends along the direction Y. A communication hole 116 is formed at the center of the barrel 112. An injection cylinder 121, which will be described later, is coupled to the communication hole 116. The communication hole 116 is provided with a check valve 124 located in a position upstream from the injection cylinder 121. The flat screw 111 is rotated by the drive motor 118 and the heater 113 produces heat under the control of the controller 500.

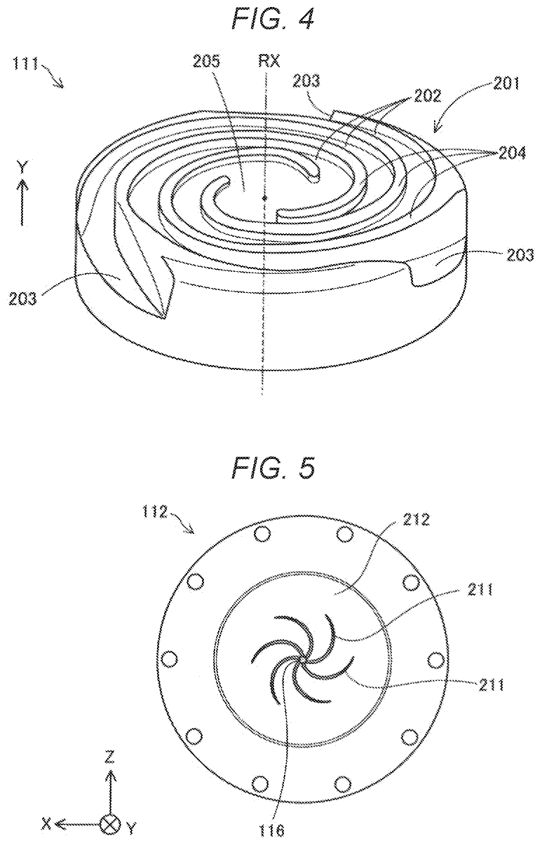

FIG. 4 is a perspective view showing a schematic configuration of the flat screw 111. The flat screw 111 has a substantially columnar shape having a height in the direction along the center axis thereof being smaller than the diameter thereof. The flat screw 111 has a groove forming surface 201, which faces the barrel 112, and spiral grooves 202 are formed in the groove forming surface 201 around a central section 205 of the flat screw 111. The grooves 202 communicate with a material loading port 203 formed at the side surface of the flat screw 111. The material supplied from the hopper 30 is supplied into the grooves 202 via the material loading port 203. The grooves 202 are formed so as to be separate from each other by convex strips 204. FIG. 4 shows that three grooves 202 are formed by way of example, and the number of grooves 202 may be one or two or more. The grooves 202 do not necessarily have a spiral shape, may instead have a helical shape or the shape of an involute curve, or may extend in an arcuate shape from the center to the periphery of the groove forming surface 201.

FIG. 5 is a schematic plan view of the barrel 112. The barrel 112 has a flat screw facing surface 212, which faces the groove forming surface 201 of the flat screw 111. The communication hole 116 is formed at the center of the flat screw facing surface 212. A plurality of guide grooves 211, which are coupled to the communication hole 116 and extend spirally from the communication hole 116 toward the periphery of the flat screw facing surface 212, are formed in the flat screw facing surface 212. The material supplied to the grooves 202 of the flat screw 111 is plasticized in the space between the flat screw 111 and the barrel 112 through the rotation of the flat screw 111 and the heat produced by the heaters 113, and the rotation of the flat screw 111 causes the material to flow along the grooves 202 and the guide grooves 211, and the material is guided to the central section 205 of the flat screw 111. The material flowing to the central section 205 flows to the injection control mechanism 120 via the communication hole 116 provided at the center of the barrel 112. The barrel 112 may not be provided with the guide grooves 211. The guide grooves 211 may not be coupled to the communication hole 116.

The injection control mechanism 120 includes the injection cylinder 121, a plunger 122, and a plunger driver 123, as shown in FIG. 3. The injection control mechanism 120 has the function of ejecting the molding material in the injection cylinder 121 and injecting the molding material into the cavity 165. The injection control mechanism 120 controls the amount, speed, and pressure of the injected molding material via the nozzle 114 under the control of the controller 500. The injection cylinder 121 is a substantially cylindrical member coupled to the communication hole 116 of the barrel 112 and includes the plunger 122 accommodated in the injection cylinder 121. The plunger 122 slides in the interior of the injection cylinder 121 and delivers under pressure the molding material in the injection cylinder 121 to the nozzle 114 provided in the injector 100. The plunger 122 is driven by the plunger drive unit 123, which is formed of a motor. The molding material delivered under pressure to the nozzle 114 is injected from the nozzle 114 into the cavity 165 through the gate opening.

In the present embodiment, the nozzle 114 is configured as a hot runner nozzle. Heaters are disposed around the nozzle 114, and the controller 500 controls the heaters to control the temperature at which the molding material is held and the temperature at which the molding material is injected. The gate of the hot runner nozzle may be an open gate or a valve gate.

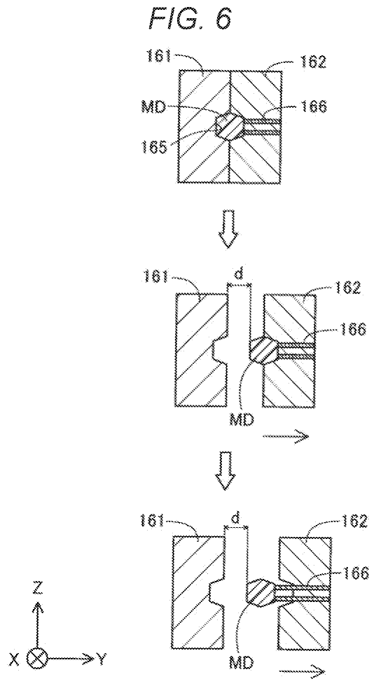

FIG. 6 is a diagrammatic view showing that the molding die 160 undergoes the die opening. After the molding material is injected into the cavity 165, the pressure of the molding material is held at a certain value, and the molding material is cooled, the die clamper 130 shown in FIG. 1 drives the ball screw 132 to move the movable die 162 by a predetermined distance in the direction +Y relative to the fixed die 161, as shown in FIG. 6. An end of the ball screw 132, the end facing the direction −Y, then comes into contact with the thrust bearing 163, so that the ejector pins 166 move no more in the direction +X. In the state described above, when the movable die 162 is further moved in the direction +Y, only the movable die 162 moves in the direction +Y with the ejector pins 166 being in contact with a molded product MD, so that the ejector pins 166 push the molded product MD in the cavity 165 relative thereto, and the molded product MD is released from the movable die 162. That is, the ejector pins 166 in the present embodiment protrude from the movable die 162 relative thereto toward the fixed die 161 as the die opening, which moves the movable die 162 from the fixed die 161, proceeds to push the molded product MD out of the movable die 162. The configuration described above eliminates the need for a mechanism that moves the ejector pins 166 themselves and simplifies the configuration of the injection molding apparatus 10.

In the injection molding apparatus 10 according to the first embodiment described above, the molding material is injected from the plurality of injection units via the gate openings into the cavity 165 defined by the fixed die 161 and the movable die 162. Specifically, for example, the molding material is injected from the first injection unit 141 via the first gate opening 171, and the molding material is injected from the second injection unit 142 via the second gate opening 172. In the present embodiment, the molding material can be injected into the single cavity 165 from the plurality of injection units 140 as described above, whereby the molding material can spread all over the interior of the cavity 165 even when the injection pressure or the die clamping pressure is low. Furthermore, according to the present embodiment, even when the cavity 165 has a large projected area, the injection pressure and the die clamping pressure necessary for the injection molding can be reduced, whereby the sizes of the injection control mechanism 120 and the die clamper 130 can be reduced as compared with the projected area of the cavity 165. The projected area of the cavity 165 is the area of the cavity 165 viewed in the direction in which the movable die 162 moves.

In the present embodiment, the injection units 140 can inject the molding material in accordance with the separately set injection conditions. Therefore, for example, an insufficient amount of filled molding material, warpage of the molded product, and other problems can be addressed by changing the injection conditions under which the injection units 140 operate without modification of the molding die or creation of a new molding die, whereby the quality of the molded product can be improved. The position of the weld line of the molded product can also be arbitrarily adjusted, for example, by changing the injection conditions under which the injection units 140 operate.

In the present embodiment, since the injection units 140 can inject not only the same molding material but also molding materials different from one another, not only can a molded product made of the same molding material be formed, but also a molded product having a plurality of portions made of different molding materials can be readily formed.

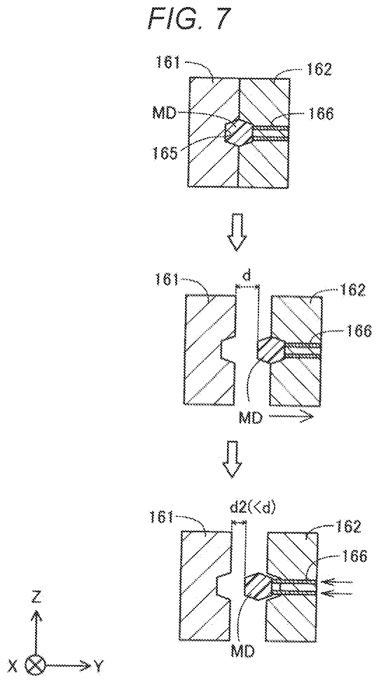

In the present embodiment, the ejector pins 166 protrude from the movable die 162 relative thereto toward the fixed die 161 as the die opening, which moves the movable die 162 from the fixed die 161, proceeds, to push the molded product MD out of the movable die 162, as shown in FIG. 6. In contrast, in Comparative Example shown in FIG. 7, the movable die 162 is moved by a predetermined distance in the direction +Y relative to the fixed die 161, the movable die 162 is then caused to be stationary, and the ejector pins 166 themselves are moved in the direction −Y. Therefore, in Comparative Example, the molded product MD moves as the ejector pins 166 move, so that a distance d2 between the fixed die 161 and the molded product MD at the time of the release of the molded product MD is shorter than a distance d between the fixed die 161 and the molded product MD before the ejector pins 166 are moved in the direction −Y. That is, the movement of the ejector pins 166 themselves increases the possibility of variation in the position where the molded product MD is released whenever the molding is performed. In the present embodiment, however, the movable die 162 is moved in place of the ejector pins 166 to release the molded product, as shown in FIG. 6, whereby the molded product MD can be released out of the movable die 162 with no change in the distance d between the fixed die 161 and the molded product before and after the release operation. The molded product can therefore be removed with high precision by a robot or any other remover.

In the present embodiment, since the plasticizer 110 employs the flat screw 111, the size of the injection molding apparatus 10 can be reduced.

In the present embodiment, since the injection molding apparatus 10 is a horizontal injection molding apparatus, and the movable die 162 moves in a direction that intersects with the vertical direction to perform the die clamping, the movable die 162 can be moved with a smaller force than in a case where the movable die 162 is moved vertically upward.

(A-1) In the first embodiment described above, the injection units 140 are arranged in two rows in each of the directions X and Z in the injector 100. In contrast, the number of injection units 140 and gate openings only need be two or more, and are arbitrarily changeable in accordance with the projected area and shape of the cavity 165. The arrangements of the injection units 140 and the gate openings are also arbitrarily changeable in accordance with the projected area and shape of the cavity 165.

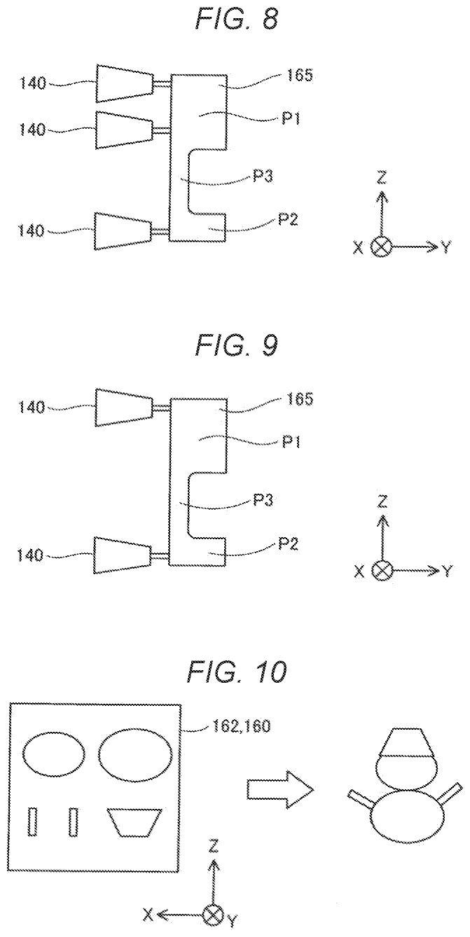

FIG. 8 is a first view showing an example of the arrangement of the injection units 140 with respect to the cavity 165. FIG. 8 shows the shape of a cavity 165 including a first section P1 having a first volume and a second section P2 having a volume smaller than that of the first section P1, the first section P1 and the second section P2 communicating with each other via a passage P3. Using the cavity 165 described above, arranging two gate openings for the first section P1 and one gate opening for the second section P2, and arranging the injection units 140 in correspondence with the gate openings allow the molding material to be injected from the two injection units 140 toward the first section P1, which has a large volume. The molding material can thus satisfactorily spread all over the interior of the cavity 165.

FIG. 9 is a second view showing an example of the arrangement of the injection units 140 with respect to the cavity 165. FIG. 9 shows a cavity 165 having the same shape as that of the cavity 165 shown in FIG. 8. For example, even in a case where a single injection unit 140 is disposed for each of the first section P1 having a large volume and the second section P2 having a small volume, as shown in FIG. 9, the embodiment described above allows the injection conditions to be set separately for each of the injection units 140. Therefore, for example, increasing the injection speed or the injection pressure at which the injection unit 140 that injects the molding material toward the first section P1 performs the injection, as compared with the injection speed or the injection pressure at which the injection unit 140 that injects the molding material toward the second section P2 performs the injection, allows the molding material to satisfactorily spread all over the interior of the cavity 165.

(A-2) In the first embodiment described above, the molding material is injected from the plurality of injection units 140 toward the single cavity 165. In contrast, the cavity 165, which is defined by the fixed die 161 and the movable die 162, may have, for example, a first cavity that communicates with the first gate opening and a second cavity that is separate from the first cavity and communicates with the second gate opening. That is, a plurality of cavities may be formed in the molding die 160, and the molding material may be injected from separate injection units 140 toward the respective cavities, as shown in FIG. 10. Different injection conditions can thus be applied to the respective cavities, preventing quality variation caused by differences in the layout of the individual cavities in the molding die.

When the individual cavities have shapes different from one another, a plurality of molded products having the different shapes can be formed in a single injection action performed by the injection units 140, as shown in FIG. 10. What is called family mold can therefore be readily achieved.

When the individual cavities are independent of one another as shown in FIG. 10, and there is only one injection unit 140, the molding material is divided by using runners, and the divided molding materials are supplied to the cavities. To this end, large injection pressure and large die clamping pressure are necessary. According to the embodiment described above, however, since the molding material can be injected toward the cavities from the plurality of injection units 140, the molding material readily spreads all over the interior of each of the cavities even when the injection pressure or the die clamping pressure is low.

FIG. 10 shows the case where the individual cavities have shapes different from one another, and the individual cavities may instead all have the same shape. In this case, a plurality of molded products having the same shape can be formed in a single injection action performed by the injection units 140.

(A-3) In the first embodiment described above, the injection units 140 can each inject a molding material containing a fiber material, such as carbon fibers and glass fibers. For example, employing the molding material containing a fiber material as the first and second molding materials, and causing the first injection unit 141 and the second injection unit 142 to perform injection in accordance with different injection conditions allow formation of a molded product formed of a portion formed by using the first molding material and a portion formed by using the second molding material, the portions being different from each other in terms of orientation of the fiber material. For example, when the injection pressure or speed at which the first injection unit 141 performs injection is greater than the injection pressure or speed at which the second injection unit 142 performs injection, the degree of the orientation of the fiber material in the molding material injected from the first injection unit 141 can be greater than the degree of the orientation of the fiber material in the molding material injected from the second injection unit 142. The configuration described above allows the orientation of the fiber material to differ from one another among the portions of the molded product. When the cavity is divided into a plurality cavities, as shown in FIG. 10, a molded product containing fiber materials having different orientations on a cavity basis can be formed.

(A-4) In the embodiment described above, the injection molding apparatus 10 causes the ejector pins 166 to relatively protrude from the movable die 162 toward the fixed die 161 by moving the movable die 162. In contrast, the injection molding apparatus 10 may cause the ejector pins 166 to protrude from the movable die 162 by moving the ejector pins 166 themselves, as shown in FIG. 6.

### B. Second Embodiment

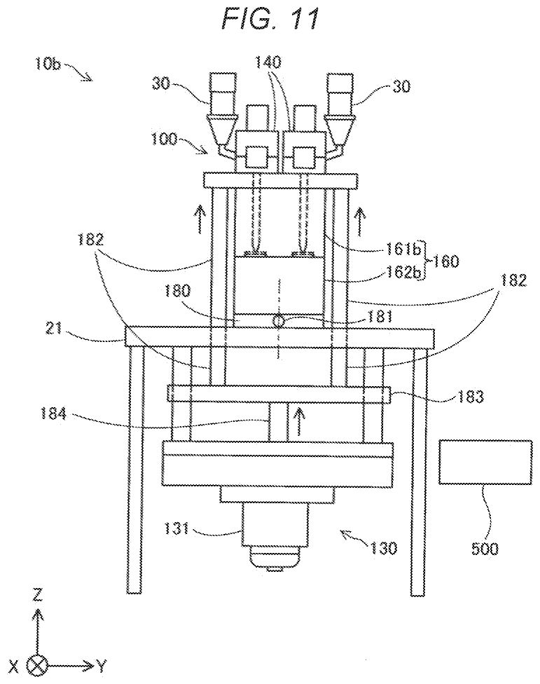

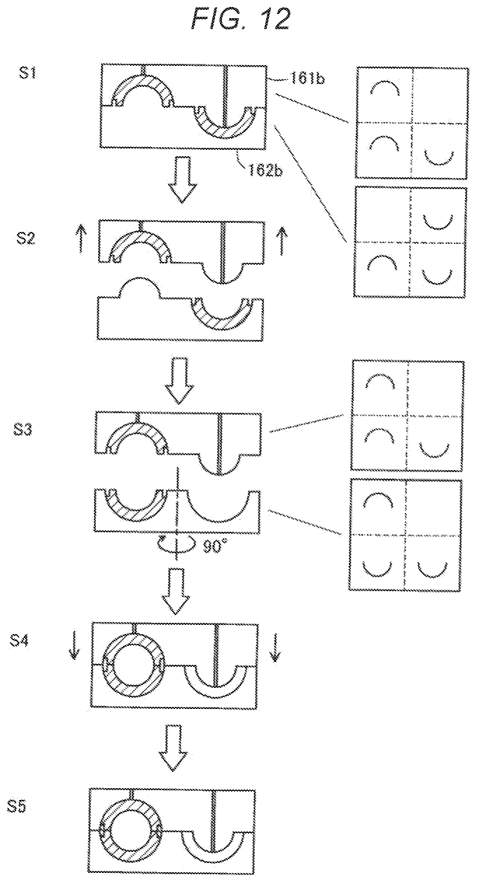

FIG. 11 shows a schematic configuration of an injection molding apparatus 10b according to a second embodiment. One difference between the first and second embodiments is that the injection molding apparatus 10 according to the first embodiment is a horizontal injection molding apparatus, whereas the injection molding apparatus 10b according to the second embodiment is a vertical injection molding apparatus. Another difference between the first and second embodiments is that in the first embodiment, one injection action is performed by the injection units 140 toward the cavity 165 during one die clamping action to complete a molded product, whereas in the second embodiment, the die clamping is performed multiple times and injection is performed in each of the die clamping actions to complete a molded product.

The injection molding apparatus 10b is formed of the injector 100, the molding die 160, and the die clamper 130 arranged from above in the vertical direction. The molding die 160 includes an upper die 161b and a lower die 162b. The upper die 161b corresponds to the fixed die 161 in the first embodiment, and the lower die 162b corresponds to the movable die 162 in the first embodiment.

In the second embodiment, the die clamper 130 is disposed below a base 21. The die clamper 130 drives a ball screw 184 under the control of the controller 500 to raise and lower pillars 182, which pass through the base 21, via a movable plate 183. The injector 100 and the upper die 161b fixed to the pillars thus move along the vertical direction to perform the die opening and the die clamping. The lower die 162b is disposed on a rotary table 180 fixed to the base 20. The rotary table 180 is rotationally driven by a drive motor 181 under the control of the controller 500. That is, in the present embodiment, the lower die 162b is configured to be rotatable.

FIG. 12 is a descriptive diagram showing an example of the molding process in the second embodiment. The right side of FIG. 12 diagrammatically shows the shapes of the recesses and protrusions of the upper die 161b and the lower die 162b viewed from above. In step S1, after the die clamping, the injection units 140 perform injection toward two corresponding, horizontally arranged cavities for primary molding. The cavity on the left in FIG. 12 forms a first hemisphere having an upwardly convex shape, and the cavity on the right in FIG. 12 forms a second hemisphere having a downwardly convex shape. In step S2, the die opening is performed, and in step S3, the rotary table 180 rotates the lower die 162b by 90°. The first and second hemispheres formed in step S1 therefore face each other. In this state, the die clamping is performed in step S4, and secondary molding is performed in step S5. In the secondary molding, the molding material is supplied to the portion where the first and second hemispheres are coupled to each other, and the first and second hemispheres are joined to each other. The following die opening completes a hollow, spherical molded product.

According to the second embodiment, the molding material can be injected toward the plurality of cavities from the plurality of injection units 140. Furthermore, since the lower die 162b is configured to be rotatable, a molded product having a hollow body or an undercut can be readily formed. In the second embodiment, since the lower die 162b rotates, the entire injection molding apparatus can be more compact than an injection molding apparatus having a structure in which the die is caused to slide, as in die slide injection molding (DSI).

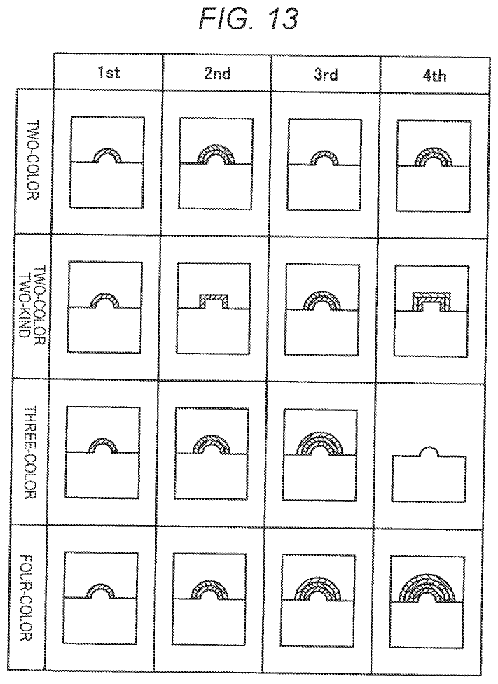

FIG. 12 shows an example of molding a hollow molded product, and forming two to four cavities in the molding die and causing the injection units to perform injection whenever the lower die 162b is rotated by 90° allow a variety of types of molding, such as two-color molding, two-color two-kind molding, three-color molding, and four-color molding, for example, as shown in FIG. 13.

FIG. 11 shows the vertical injection molding apparatus 10b, and the horizontal injection molding apparatus 10 shown in FIG. 1 can also form a hollow molded product and perform multicolor molding described above by configuring the movable die 162 to be rotatable.

### C. Other Embodiments

(C1) In the embodiments described above, part or all of the plurality of injection units 140 may employ a plasticizer including an in-line screw in place of the flat screw 111.

(C2) In the embodiments described above, the injection molding apparatus 10 may employ a cold runner in place of a hot runner. Part of the plurality of injection units 140 may include hot runner nozzles.

### D. Other Aspects

The present disclosure is not limited to the embodiments described above and can be achieved in a variety of configurations to the extent that they do not depart from the substance of the present disclosure. For example, the technical features described in the embodiments and corresponding to the technical features in the aspects described below can be replaced with other features or combined with each other as appropriate to solve part or entirety of the problems described above or achieve part or entirety of the effects described above. Furthermore, when any of the technical features has not been described as an essential feature in the present specification, the technical feature can be deleted as appropriate.

According to a first aspect of the present disclosure, an injection molding apparatus is provided. The injection molding apparatus includes a fixed die having a first gate opening and a second gate opening formed therein, a movable die configured to be clampable to the fixed die, a first injection unit that injects a first molding material into a cavity defined by the fixed die and the movable die via the first gate opening, and a second injection unit that injects a second molding material into the cavity via the second gate opening.

According to the aspect described above, the molding material can be injected from each of the first and second injection units even when the cavity has a large projected area, whereby necessary injection pressure and die clamping pressure can be lowered. The size of the injection molding apparatus can therefore be reduced.

(2) In the aspect described above, the second injection unit may inject the second molding material into the cavity into which the first injection unit injects the first molding material. According to the aspect described above, a single molded product can be formed in a single injection action performed by the injection units.

(3) In the aspect described above, the cavity may have a first cavity that communicates with the first gate opening and a second cavity that is defined so as to separate from the first cavity and communicates with the second gate opening. According to the aspect described above, a plurality of molded products can be formed in a single injection action performed by the injection units.

(4) In the aspect described above, the first cavity and the second cavity may have shapes different from each other. According to the aspect described above, a plurality of molded products having shapes different from one another can be formed in a single injection action performed by the injection units.

(5) In the aspect described above, the movable die may move in a direction that intersects with the vertical direction to perform the die clamping. According to the aspect described above, the movable die can be moved with a force smaller than the force required to move the movable die vertically upward.

(6) In the aspect described above, the molded product may be formed by performing operation once including die clamping of the fixed die and the movable die and injection from each of the first and second injection units into the cavity.

(7) In the aspect described above, the first molding material and the second molding material may be the same material or different materials. According to the aspect described above, a molded product can be formed by using the same material or different materials.

(8) In the aspect described above, the first and second injection units may perform injection in accordance with separately set injection conditions. According to the aspect described above, the quality of the molded product can be improved.

(9) In the aspect described above, the first and second molding materials may each contain a fiber material, and the first and second injection units may perform injection in accordance with different injection conditions to form a molded product formed of a portion formed by using the first molding material and a portion formed by using the second molding material, the portions being different from each other in terms of orientation of the fiber material. The aspect described above allows the orientation of the fiber material to differ from one another among the portions of the molded product or among the molded product.

(10) In the aspect described above, the injection molding apparatus may include an ejector pin that protrudes from the movable die relative thereto toward the fixed die as the die opening, which moves the movable die from the fixed die, proceeds to push the molded product out of the movable die. According to the aspect described above, the configuration of the injection molding apparatus can be simplified.

(11) In the aspect described above, at least one of the first and second injection units may include a plasticizer including a screw rotating around an axis of rotation and having a groove forming surface that has a groove formed therein, and a barrel having a screw facing surface that faces the groove forming surface and having a communication hole which is provided in the screw facing surface and through which the molding material flows out. According to the aspect described above, the size of the injection units can be reduced.

What is claimed is:

1. An injection molding apparatus comprising:
a fixed die having a first gate opening and a second gate opening formed therein;
a movable die configured to be clampable to the fixed die;
a first injection unit that injects a first molding material into a cavity defined by the fixed die and the movable die via the first gate opening; and
a second injection unit that injects a second molding material into the cavity via the second gate opening.

2. The injection molding apparatus according to claim 1,
wherein the second injection unit injects the second molding material into the cavity into which the first injection unit injects the first molding material.

3. The injection molding apparatus according to claim 1,
wherein the cavity has a first cavity that communicates with the first gate opening and a second cavity that is defined so as to separate from the first cavity and communicates with the second gate opening.

4. The injection molding apparatus according to claim 3,
wherein the first cavity and the second cavity have shapes different from each other.

5. The injection molding apparatus according to claim 1,
wherein the movable die moves in a direction that intersects with a vertical direction to perform die clamping.

6. The injection molding apparatus according to claim 1,
wherein the molded product is formed by performing operation once including die clamping of the fixed die and the movable die and injection from each of the first and second injection units into the cavity.

7. The injection molding apparatus according to claim 1,
wherein the first molding material and the second molding material are the same material or different materials.

8. The injection molding apparatus according to claim 1,
wherein the first and second injection units perform injection in accordance with separately set injection conditions.

9. The injection molding apparatus according to claim 8,
wherein the first and second molding materials each contain a fiber material, and
the first and second injection units perform injection in accordance with different injection conditions to form a molded product formed of a portion formed by using the first molding material and a portion formed by using the second molding material, the portions being different from each other in terms of orientation of the fiber material.

10. The injection molding apparatus according to claim 1,
further comprising an ejector pin that protrudes from the movable die relative thereto toward the fixed die as die opening, which moves the movable die from the fixed die, proceeds to push a molded product out of the movable die.

11. The injection molding apparatus according to claim 1,
wherein at least one of the first and second injection units includes a plasticizer rotating around an axis of rotation and including a screw having a groove forming surface that has a groove formed therein, and a barrel having a screw facing surface that faces the groove forming surface and having a communication hole which is provided in the screw facing surface and through which a molding material flows out.
